(19) United States
(12) Patent Application Publication
(10) Pub. No.: US 2016/0140669 A1
(43) Pub. Date: May 19, 2016

(54) MULTI-ATTITUDE SUPPORT WITHIN SOCIAL NETWORK SPACE

(71) Applicant: International Business Machines Corporation, Armonk, NY (US)

(72) Inventors: Peter A. Balinski, Elmhurst, NY (US); Sasikanth Eda, Vijayawada (IN); John G. Musial, Newburgh, NY (US); Sandeep R. Patil, Pune (IN); Riyazahamad M. Shiraguppi, Pune (IN)

(21) Appl. No.: 14/541,539

(22) Filed: Nov. 14, 2014

(51) Int. Cl. G06Q 50/00; G06Q 30/02; H04L 12/58; H04L 29/06; G06F 17/30

(52) U.S. Cl. CPC G06Q 50/01; H04L 65/403; G06F 17/30539; H04L 51/32; G06Q 30/0201; G06Q 30/0242

(57) ABSTRACT

Social media network system that provides for a customized recipient lists, where the customized recipient list will depend upon a mode (or “attitude”) that the user entity selects (and changes as desired). In this way, multiple social actions can conveniently be subject to the same customized recipient list, specifically the customized recipient list that was effectively selected by the user entity when selecting his/her attitude. For example, a user may choose an attitude at the beginning of a social media session, so that all social media actions performed by the user entity during that session will only be accessible by other entities on the customized recipient list associated with the user-selected attitude.

### BACKGROUND OF THE INVENTION

The present invention relates generally to the field of social media networking, and more particularly distribution of information within an entity's (for example, an individual person's) social media network space. In this document, the relevant social media entity will often be referred to as a “person,” but it should be kept in mind that there are other types of social media entities, such as corporate social media network sites. As used herein, the term “social media post” will refer to some action (for example, posting a picture) taken by a user where the access (for example, visibility access, download access, reply access) to the social media post is controlled by the manner in which the user's social media account is configured.

Social networks (for example, Facebook, Twitter, etc.) are known. (Note: the term(s) “FACEBOOK” and/or “TWITTER” may be subject to trademark rights in various jurisdictions throughout the world, and are used here only in reference to the products or services properly denominated by the marks to the extent that such trademark rights may exist.) Social media network space for entities to communicate information over computer-based communication networks provide a platform for connecting entities, such as people, companies, non-commercial organizations and so on. With the rapid technological advancement and growth of popularity, social networking communities have evolved as a source for broadcast-based communications and unicast based communications. As conventionally implemented, social network communities can also be treated as a repository/stock of all events, preferences, feelings experienced by an entity. It is conventional to “mine” social network data to identify the trend patterns, brand follow up, current state of the individual, personalized sales, etc. In fact, companies already acquire a significant amount of customers via mining the personal interest of social media entities. The current literature also deals with changes in social physiology and/or attitude change and how are they creating issues relating social network data for use to further business objectives of businesses that mine social network data.

There are many types of “social media posts” that a user can make (for example, posting a comment, posting audio visual material, writing a full review, giving a rating, making an invite to an event, making a poll, starting a “chat room,” etc.), and additional types of social media actions will likely be developed in the future. In some conventional social media systems, the user can control which other entities will be able to access a given social media action. For example, if a person makes a post, then he can choose that the only other users who see that post are, for example, his mother and father and a charity-related entity that she does volunteer work for, while other entities in the social media network cannot see the post through their respective accounts, and, generally, will have no way of knowing that the person made the post.

### SUMMARY

According to an aspect of the present invention, there is a method, computer program product and/or system for allowing a posting user to make a social media post by social media machine logic through a computer and over a communication network that performs the following steps (not necessarily in the following order): (i) configuring the posting user's social media account to include a set of attitudes including a first attitude; (ii) further configuring the posting user's account to associate each attitude of the set of attitudes with a respective set of recipients; (iii) receiving a selection, from the posting user, of the first attitude as the current attitude; (iv) receiving first posting content from the posting user; and (v) posting a first social media post, corresponding to the first posting content, such that only recipients associated with the posting user's current attitude have access to the first social media post.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (for example, software) portion of the first embodiment system;

FIG. 4 is a screenshot view generated by the first embodiment system;

FIG. 5 is a diagram that helps explain some embodiments of the present invention;

FIG. 6 is a diagram that helps explain some embodiments of the present invention;

FIG. 7 is a diagram that helps explain some embodiments of the present invention; and

FIG. 8 is a flow chart showing a second embodiment of a method according to the present invention.

### DETAILED DESCRIPTION

While there are conventional social media systems that provide for customized recipient groups for a given social media action, some embodiments of the present invention provide for a customized recipient lists, where the customized recipient list will depend upon a mode (or “attitude”) that the user chooses. In this way, multiple social actions can conveniently be subject to the same customized recipient list, specifically the customized recipient list that was effectively selected by the user entity when selecting his/her attitude. For example, a user may choose an attitude at the beginning of a social media session, so that all social media actions performed by the user entity during that session will only be accessible by other entities on the customized recipient list associated with the user-selected attitude. This Detailed Description section is divided into the following sub-sections: (i) The Hardware and Software Environment; (ii) Example Embodiment; (iii) Further Comments and/or Embodiments; and (iv) Definitions.

### The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

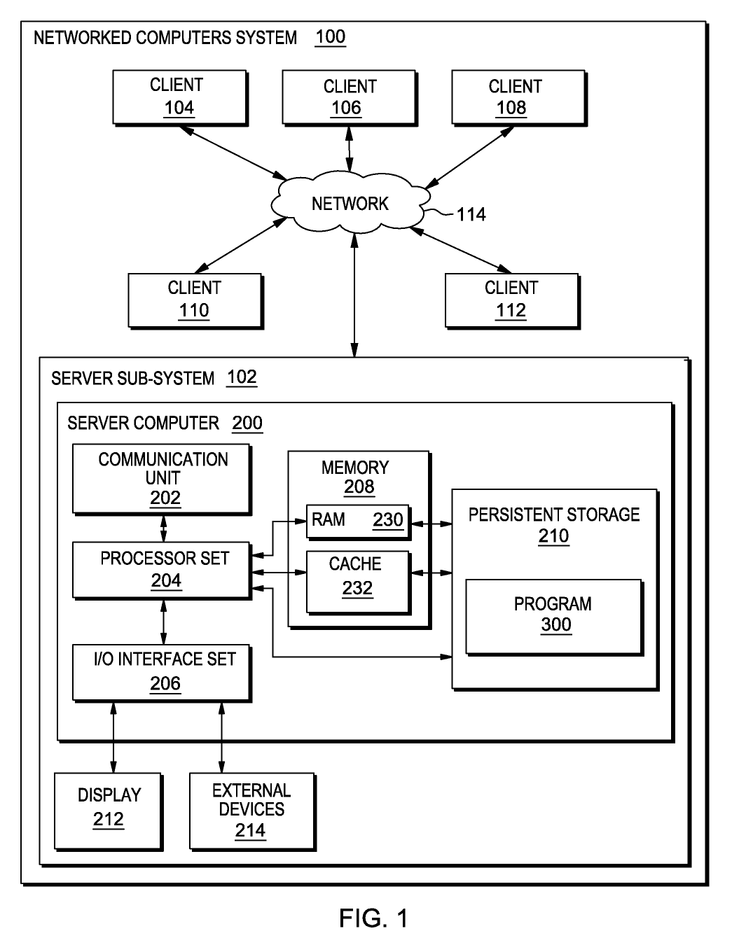

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply some, or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### Example Embodiment

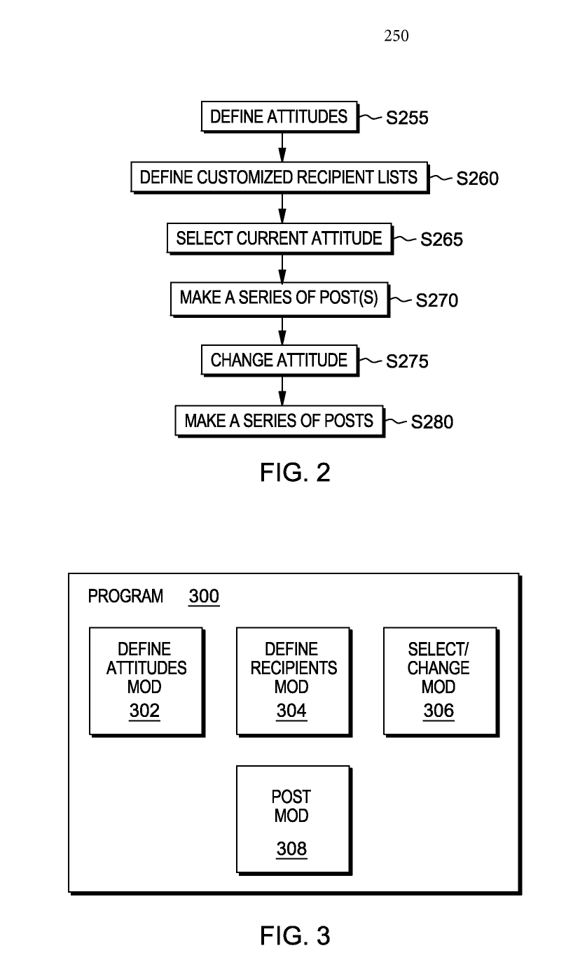

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where define attitudes module (“mod”) 302 defines a set of attitudes. More specifically, in this embodiment, a user (not separately shown) communicates through client sub-system 104 and network 114 (see FIG. 1) to indicate that he/she would like to have two attitudes included in his/her social media account, and that he/she would like to call the attitudes “happy” and “sadness.” Alternatively, the social media software may define the set of attitudes without user input, in ways such as, for example, the following: (i) a new attitude is defined when a user merges a secondary social media account into his/her primary social media account; (ii) social media software gives all users a set of pre-defined attitudes (for example, all associates, work, friends, family); and/or (iii) analytics used to analyze content of user's posts and pre-attitude, post-by-post choices of whom to send the user's old posts.

In this example, the user has chosen to create the “happy” attitude because: (i) his/her social media associates named A, B, and C tend to be a bit jealous of the user, and his/her relative success in life; and (ii) use of the “happy” attitude will allow user a convenient way to exclude A, B and C from accessing posts that the poster makes when he/she is in the happy attitude (to explain further, the user plans to use the happy attitude when she makes posts about how great his/her life is going). In this example, the user has chosen to create the “sadness” attitude because: (i) his/her social media associates named D, E and F tend toward melancholy; and (ii) use of the “sadness” attitude will allow user a convenient way to exclude D, E and F from accessing posts that the poster makes when he/she is in the sadness attitude, so as to avoid those especially sensitive to sadness. In effect, three attitudes will be defined: (i) happy; (ii) sadness; and (iii) non-specified attitude (which will include a of the user's social media associates A, B, C, D, E, F and G).

Processing proceeds to step S260, where define recipients mod 304 defines a recipient list associated with each of the attitudes defined at step S255. More specifically, in this embodiment, the user communicates through client sub-system 104 and network 114 (see FIG. 1) to indicate his/her recipient lists for each attitude, “happy” and “sadness.” Alternatively, the social media software may define the recipient lists without user input, in ways such as, for example, the following: (i) using the recipients profiles to determine which attitude(s) they should be respectively associated with; and/or (ii) analytics used to analyze content of user's posts and pre-attitude, post-by-post choices of whom to send the user's old posts. As mentioned above, the non-specified attitude is automatically set so to include all of the user's contacts (or “friends,” or “associates,” etc.)

In this example, at step S260, the user indicates, and mod 304 makes definitions, so that: (i) the “happy” attitude is to have an associated recipient list including D, E, F and G; and (ii) the “sadness” attitude is to have an associated recipient list including A, B, C and G. In this embodiment, the various attitudes (other than the attitude that includes all the user's contacts by definition) are not mutually exclusive, as demonstrated by the inclusion of G in both the “happy” and “sadness” associated recipient lists. Alternatively, some embodiments may force attitudes (other than those including all contacts) to have mutually exclusive recipient list, so that it becomes less likely that a contact not intended to see a given post will not somehow inadvertently see the post through another contact who is on multiple attitude recipient lists.

Although not a part of method 250, it is noted that the user can change attitudes and/or associated recipient lists on an ongoing basis to suit his/her evolving preferences and evolving contacts list.

Processing proceeds to step S265, where select/change mod 306 allows the user to select his/her current attitude before beginning a posting session through her social media account. In this example, the user has just lost a good friend to a terminal illness. The user knows that these posts will tend to unduly sadden his/her contacts D, E and F, who each tend toward melancholy, so he/she selects the attitude “sadness,” knowing that any posts he/she makes while in this attitude (or, “posting mode”) will go to all of his/her contacts exclusive of D, E and F.

Processing proceeds to step S270, where the user makes a series of posts through client sub-system 104, network 114 and post mod 308. In this example, he/she makes eighteen (18) posts about the friend who passed, including details of their friendship, photos of happier times, a summary of his/her friend's brave battle with the illness, and condolences to his/her friend's family. These posts include vlog type videos showing the user requesting that donations be made, in the name of his/her friend, to an appropriate medical research organization that continues to work on a cure for the disease. The URL of the online web page where donations can be pledged is also included as part of a blog posting where he/she challenges her social media community to spread the word about funding research to find a cure for this horrible disease.

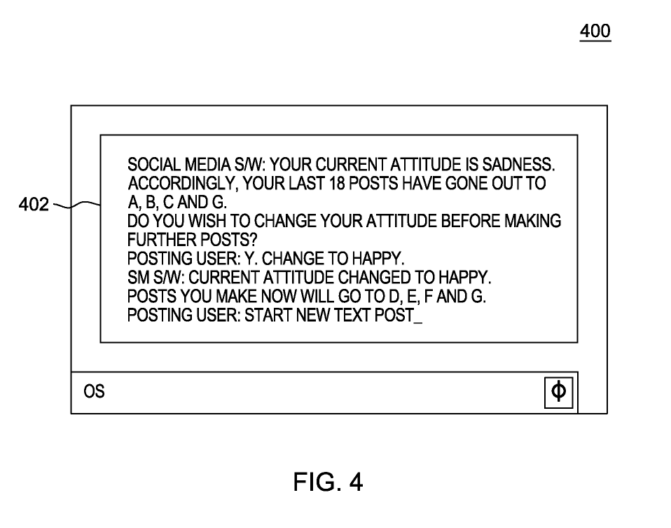

Processing proceeds to step S275 where the user changes his/her attitude (or posting mode) through client sub-system 104, network 114, and select/change mod 306. More specifically, the user changes from “sadness” to “happy” because he/she is about to stop posting about the loss of his/her dear friend and start posting about the wonderful opportunity he/she has just been offered as part of a new research internship. The user knows that A, B and C will be quite jealous of this extraordinary opportunity so he/she switches from sadness attitude to happy attitude to: (i) put D, E and F on the recipient for posts on a going-forward basis; and (ii) exclude A, B and C from the recipient lists for these planned posts. As shown in FIG. 4, a user interface for making this change is shown at screenshot 402 of display 400.

Processing proceeds to step S280, where the user makes a series of posts using the happy attitude through client sub-system 104, network 114, and post mod 308. Steps S270 and S280 show how the preset invention allows a user to use attitudes (or posting modes) to control the recipient list for a whole series of posts, instead of attempting to control the recipient list on a post-by-post basis.

### Further Comments and/or Embodiments

Some embodiments of the present invention may include one, or more, of the following features, characteristics, and/or advantages: (i) design for social network forums, such that it enables a provision/flexibility for exhibiting multi-attitude/character within associated social network activities; (ii) instead of hiding the post/comment from a particular group, the user will be provided with a flexibility that such he/she can post a different set of comments such that he/she does not need to hide their feelings from others; and/or (iii) provides a way for a user to exhibit a multi-behavior in social network forums.

Consider an example of a teenager who likes photography (in real life), and his behavior towards photography varies in presence of different people according to the following pattern: (i) with his parents, he regards photography as a less important subject than traditional classroom education; (ii) with his schoolmates, he is regarded, and cultivates recognition, as an expert of photography (for example, he sometimes helps schoolmates to take better photographs); and (iii) with his “college mates,” he is regarded, and cultivates recognition, as being relatively uninterested in photography, but instead interested in music (with an emphasis on songs relating to romantic love). Now consider a situation where the teenager has to comment over a photograph posted by one of his child hood friend. By using an embodiment of the present invention, the user may make this comment in the following way: (i) define recipient lists for the following three (3) attitudes: (a) parents, (b) school mates and (c) college mates; (ii) select attitude “parents;” (iii) post a comment stating “good work,” which will only be visible only to his parents and grandparents; (iv) re-select attitude to “school mates;” (v) post a comment stating “nice work, but need to improve in adjusting contrast,” which will only be visible to his school mates; (vi) re-select attitude to “college mates;” and (vii) post a comment stating “special photograph when I look at it I can hear the song ‘Love To Love My Love On This Lovely Day’ playing in my head,” which comment will be visible only to his college mates. By using the attitudes (and respectively associated recipient lists) of the present invention: (i) the parents feel that the teenager is giving good importance to studies; (ii) school mates think that the teenager has retained his photography skill; and (iii) college mates think that the user has good taste in songs of romantic love. In this way, the user can manage his relations with multi-attitude behavior in social life, too.

Some embodiments of the present invention extend multi-attitude behavior to businesses that mine social media data. Examples based on the hypothetical teenaged social media user discussed in the previous paragraph: (i) when the user embarks alone on a shopping trip, advertisers may propose photographs or camera material to him such that these things have high chance of purchase; (ii) the user goes on a shopping with his parents, advertisers propose book or study material to him such that these things have high chance of purchase; (iii) when the user comes for a shopping with his school mates, advertisers propose high/advanced camera material to him such that these things have high chance of purchase; and/or (iv) when the user goes on a shopping trip with his college mates, advertisers propose music or lyric material to him such that these things have high chance of purchase.

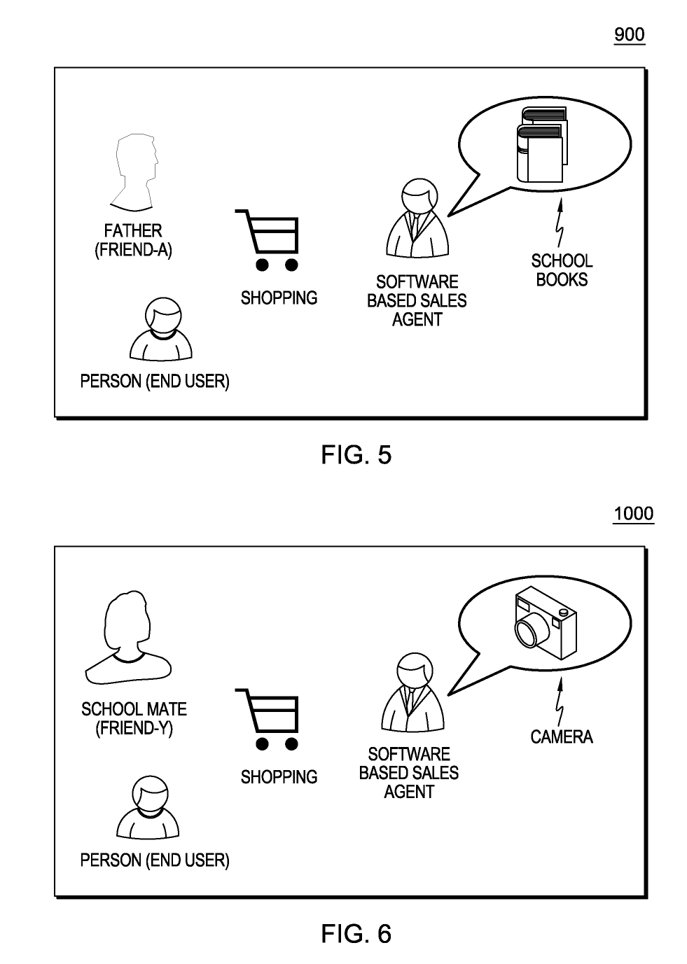

As shown in FIG. 5, diagram 900 shows “Person (End User)” on a shopping trip with “Father (Friend A).” In this example, the excursion to the stores is a non-virtual excursion to “brick and mortar” stores. Alternatively, the shopping trip could be online shopping as well where both people are shopping “together” on the same merchant's website while they chat back and forth (private chat, text messages, etc.), and also post about it on social media as they are shopping “together”. The tendencies and/or typical behavior of “Person (End User),” specifically in the presence “Father (Friend-A),” is identified from: (i) information manually entered at the time he set up the attitude “Parents,” and decided to include “Father (Friend-A)” in the recipient list associated with this attitude; and/or (ii) the content of social media activities made within the “Parents” attitude (such as the posting of pictures of classrooms and school lectures). In this example, the tendencies specific to the “Parents” attitude are determined to be school and education. In this way, the multi-attitude social media system of the present invention allows an advertiser, who uses mined social media data, to choose to try to sell schoolbooks when the advertiser determines that the user is: (i) shopping; and (ii) with a member of the “Parents” recipient list. When the end user (Person) comes for a shopping with Friend-A, the software-based sales agent proposes book or study material to him, such that these things have high chance of purchase.

As shown in diagram 1000 of FIG. 6, the end user's likely behavior in the presence of “Schoolmate (Friend-Y)” now relevant because the end user is shopping with “Schoolmate (Friend-Y)” present. For in-person shopping, some social media services have location services that can be used to determine that two users are going on a shopping trip together. First, it is determined that “Schoolmate (Friend-Y)” is on the user's recipient list for the attitude “Schoolmates.” This means that social media generated in, and/or under, the “Schoolmates” attitude can be considered in deciding what products or services to propose to the user while he is shopping with “Schoolmate (Friend-Y).” In this example, when the end user (Person) comes for a shopping with Friend-Y, the software-based sales agent proposes camera or lens material to him such that these things have high chance of purchase.

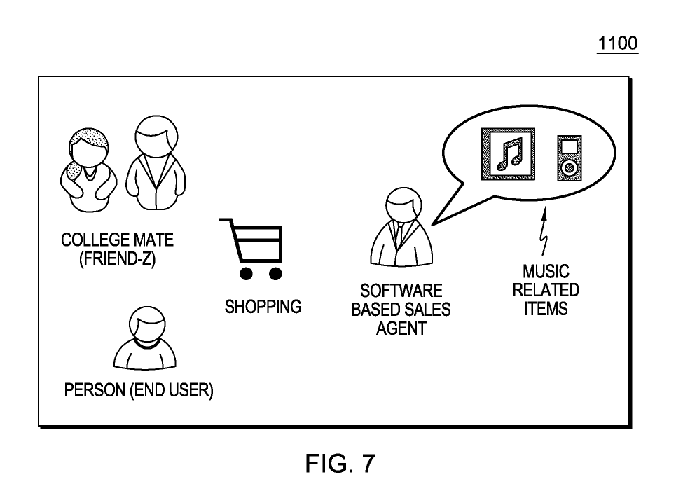

As shown in diagram 1100 of FIG. 7, the end user's behavior in the presence of Friend-Z is identified from the same multi-attitude/behavior social network and facilities a successful sale. In this example, when the end user (Person) comes for a shopping with Friend-Z, the software-based sales agent proposes music or lyric material to him such that these things have high chance of purchase.

Some embodiments of the present invention may include one, or more, of the following features, characteristics, and/or advantages: (i) form a specialized button in the end users social network workspace such that he/she can switch accordingly between single attitude and multi-attitude/behavior; (ii) in the multi-attitude mode, each incoming activity to his workspace is tread as an unique container, and the comments/likes posted by other friends to this container are stored as unique objects mapped to this container; (iii) form a multi-attitude tab (a pre-configured setting/arrangement of users/group) which forms a master box (for example, the user forms three (3) multi-attitude tabs such as family, childhood, office, and the social network forum internally creates three (3) master boxes respectively corresponding to each attitude); (iv) replicate each incoming container along with its associated objects to each master box (in one example, the user has three (3) master boxes, and all three (3) include replicated content of a single incoming activity along with its data such as comments, likes, etc.); and/or (v) end user has to select a friend/user/group/community within each master box (can be a pre-configured) such that his/her comment entered in this master box will be visible to this configured user/friend and all other comments posed by other friends remain intact in the box (any further response to end user's comment are directed appropriately to the other master boxes to which the initiator originally belong to).

Some embodiments of the present invention may include one, or more, of the following features, characteristics and/or advantages: (i) user will be provided flexibility to update his/her comments/likes separately/independently to each master box (that is, each attitude); (ii) business analytics are run upon each container to understand/analyze the users behavior change in presence of the configured user at each master box; and/or (iii) during window shopping the individual along with the user is estimated and products are exhibited to user such that it maintains the same behavior with the recipient individual as managed in real life as well as in social network (online) life.

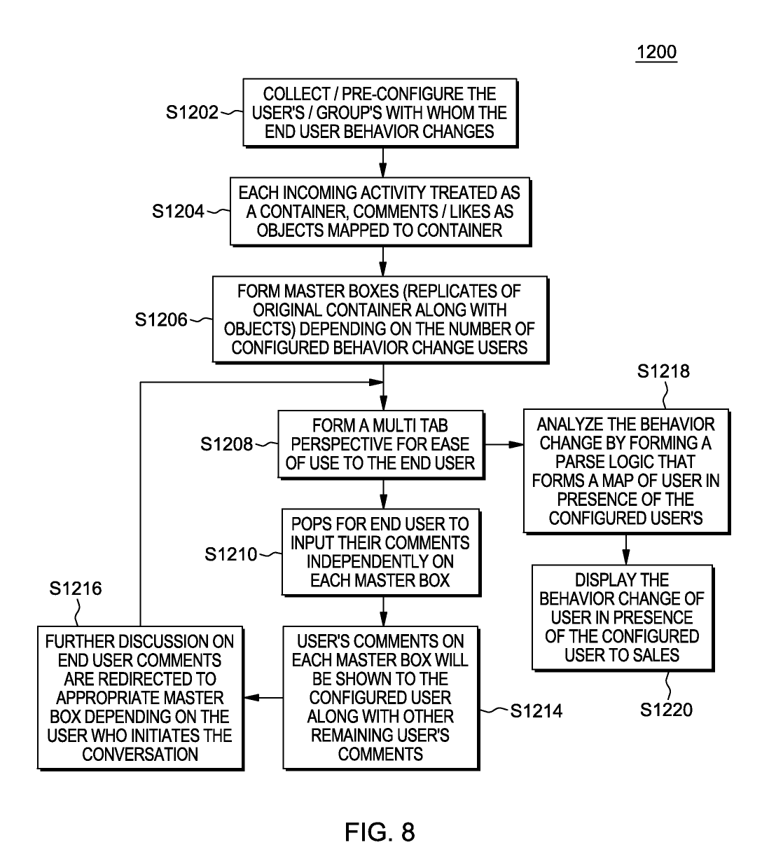

As shown in FIG. 8, flow chart 1200 shows a method for both allowing an end user to interact in a multi-attitude environment according to the present invention, and also to use information generated in context of the multi-attitude environment in order to target advertising to the user based on: (i) the identity of an entity with whom the user is currently interacting; (ii) the identity of recipient lists (respectively associated with attitude(s)) in which the user's current companion is included; and (iii) information directly present in, and/or inferable from, the users activities in, or under the attitudes associated with the user's current companion. As shown in FIG. 8, the method of flow chart 1200 includes the following operations (with process flow among and between the various operations being shown by the arrows in FIGS. 8): S1202; S1204; S1206; S1208; S1210; S1214; S1216; S1218; and S1220.

Some embodiments of the present invention may include one, or more, of the following features, characteristics, and/or advantages: (i) a design in social network that enables multi-attitude support within an individual's social network account such that it helps him/her to maintain his/her separate behavior/attitude towards each individual/group in the community; (ii) design that forms an effective reliability in the social network data for business; (iii) helps user entity's maintain “original character,” rather than forming an unrealistic behavior mask in social network; and and/or (iv) improves performance related to personal privacy concerns.

Some embodiments of the present invention may include one, or more, of the following features, characteristics and/or advantages: (i) multi-attitude support within an individual's social network account, such that it helps user to maintain separate behavior towards each individual/group in the community; (ii) framework design that enables a feature to comment differently to different individuals for a single set of post/activity; and/or (iii) forming a policy or rule which can be further used; business analytics are run upon each container to analyze the users behavior change in presence of the other user.

### Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method of allowing a posting user to make a social media post by social media machine logic through a computer and over a communication network, the method comprising:
configuring the posting user's social media account to include a set of attitudes including a first attitude;
further configuring the posting user's account to associate each attitude of the set of attitudes with a respective set of recipients;
receiving a selection, from the posting user, of the first attitude as the current attitude;
receiving first posting content from the posting user; and
posting a first social media post, corresponding to the first posting content, such that only recipients associated with the posting user's current attitude have access to the first social media post.

2. The method of claim 1 further comprising:
receiving second posting content from the posting user; and
posting a second social media post, corresponding to the second posting content, such that only recipients associated with the posting user's current attitude have access to the first social media post.

3. The method of claim 1 wherein the set of attitudes further includes a second attitude, the method further comprising:
receiving an attitude change, from the posting user, indicating a desire to change from the first attitude to the second attitude;
responsive to the attitude change, selecting the second attitude as the current attitude;
receiving second posting content from the posting user; and
posting a second social media post, corresponding to the first posting content, such that only recipients associated with the user's current attitude have access to the second social media post.

4. The method of claim 1 wherein the first social media post includes at least one of the following types of content: image, video, natural language, text, audio, computer code, access codes, voting, “liking,” “following,” and/or downloadable content.

5. The method of claim 1 wherein the access includes at least one of the following types of access: read access, partial read access, view access, partial view access, listen access, partial listen access, reply access, and/or download access.

6. The method of claim 1 further comprising:
mining social media data that includes the first social media post and an identity of users that can access the post based upon the current attitude of the posting user at the time the first post was made.

7. The method of claim 6 further comprising:
applying business analytics to the mined social media data to generate business analytics output;
selecting first communication contents based at least in part upon the business analytics output; and
sending a first communication, including the first communication contents, to the posting user.

8. The method of claim 7 wherein the first communication contents are an advertisement for a product and/or service.

9. The method of claim 1 further comprising:
receiving, from the posting user, the set of attitudes including a first attitude.

10. The method of claim 1 further comprising:
receiving association data, from the posting user, so that the associate data determines the configuring of the posting user's account to associate each attitude of the set of attitudes with a respective set of recipients.

11. A computer program product for allowing a posting user to make a social media post by social media machine logic through a computer and over a communication network, the computer program product comprising a computer readable storage medium having stored thereon:
first program instructions programmed to configure the posting user's social media account to include a set of attitudes including a first attitude;
second program instructions programmed to further configure the posting user's account to associate each attitude of the set of attitudes with a respective set of recipients;
third program instructions programmed to receive a selection, from the posting user, of the first attitude as the current attitude;
fourth program instructions programmed to receive first posting content from the posting user; and
fifth program instructions programmed to post a first social media post, corresponding to the first posting content, such that only recipients associated with the posting user's current attitude have access to the first social media post.

12. The product of claim 11 wherein the storage medium further has stored thereon:
sixth program instructions programmed to receive second posting content from the posting user; and
seventh program instructions programmed to post a second social media post, corresponding to the second posting content, such that only recipients associated with the posting user's current attitude have access to the first social media post.

13. The product of claim 11 wherein the set of attitudes further includes a second attitude, the storage medium having further stored thereon:
sixth program instructions programmed to receive an attitude change, from the posting user, indicating a desire to change from the first attitude to the second attitude;
seventh program instructions programmed to, responsive to the attitude change, select the second attitude as the current attitude;
eighth program instructions programmed to receive second posting content from the posting user; and
ninth program instructions programmed to post a second social media post, corresponding to the first posting content, such that only recipients associated with the user's current attitude have access to the second social media post.

14. The product of claim 11 wherein the first social media post includes at least one of the following types of content: image, video, natural language, text, audio, computer code, access codes, voting, “liking,” “following,” and/or downloadable content.

15. The product of claim 11 wherein the access includes at least one of the following types of access: read access, partial read access, view access, partial view access, listen access, partial listen access, reply access, and/or download access.

16. A computer system for allowing a posting user to make a social media post by social media machine logic through a computer and over a communication network, the computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to configure the posting user's social media account to include a set of attitudes including a first attitude;
second program instructions programmed to further configure the posting user's account to associate each attitude of the set of attitudes with a respective set of recipients;
third program instructions programmed to receive a selection, from the posting user, of the first attitude as the current attitude;
fourth program instructions programmed to receive first posting content from the posting user; and
fifth program instructions programmed to post a first social media post, corresponding to the first posting content, such that only recipients associated with the posting user's current attitude have access to the first social media post.

17. The system of claim 16 wherein the storage medium further has stored thereon:
sixth program instructions programmed to receive second posting content from the posting user; and
seventh program instructions programmed to post a second social media post, corresponding to the second posting content, such that only recipients associated with the posting user's current attitude have access to the first social media post.

18. The system of claim 16 wherein the set of attitudes further includes a second attitude, the storage medium having further stored thereon:
sixth program instructions programmed to receive an attitude change, from the posting user, indicating a desire to change from the first attitude to the second attitude;
seventh program instructions programmed to, responsive to the attitude change, select the second attitude as the current attitude;
eighth program instructions programmed to receive second posting content from the posting user; and
ninth program instructions programmed to post a second social media post, corresponding to the first posting content, such that only recipients associated with the user's current attitude have access to the second social media post.

19. The system of claim 16 wherein the first social media post includes at least one of the following types of content: image, video, natural language, text, audio, computer code, access codes, voting, “liking,” “following,” and/or downloadable content.

20. The system of claim 16 wherein the access includes at least one of the following types of access: read access, partial read access, view access, partial view access, listen access, partial listen access, reply access, and/or download access.
